(19) United States
(12) Patent Application Publication
(10) Pub. No.: US 2011/0093441 A1
(43) Pub. Date: Apr. 21, 2011

(54) Method for Detecting a Delinquent Customer Record in a CRM Database

(76) Inventor: Brad JACKSON, Coorparoo (AU)

(21) Appl. No.: 12/905,207

(22) Filed: Oct. 15, 2010

(30) Foreign Application Priority Data
Oct. 19, 2009 (AU) 2009905090

(51) Int. Cl. G06F 17/30

(52) U.S. Cl. 707/689; 707/E17.005

(57) ABSTRACT

The present invention relates to a method for detecting a delinquent or dormant customer record in a customer relationship management (CRM) database using a computer arrangement. The method includes the step of determining that the customer record does not relate to an existing customer for whom work is in progress. It is also determined that the customer record does not relate to a prospective customer. The method further includes the step of detecting the customer record when a future activity date associated with the customer record has passed.

### TECHNICAL FIELD

The present invention relates to a method for detecting a delinquent or dormant customer record in a customer relationship management (CRM) database.

### BACKGROUND

The reference to any prior art in this specification is not, and should not be taken as an acknowledgement or any form of suggestion that the prior art forms part of the common general knowledge.

Sales people are often judged upon the amount of product sold to customers. In some cases, sales people are on commission based upon the amount of product which they sell. Accordingly, sales people traditionally kept diaries to maintain a relationship with their customers with a view of increasing future product sales.

In more recent times, sales people use customer relationship management (CRM) software products specifically designed to assist with managing their relationships with customers, including the capture, storage and analysis of customer information. These software products enable the sales person to access data relating to prospective and existing clients stored within a CRM database.

The present applicant has found that in practice, a large proportion of customer records in well established CRM databases are delinquent or dormant which is not only inefficient, but results in missed potential sales opportunities through inaction as sales people are not aware of their existence.

### SUMMARY OF THE INVENTION

According to one aspect of the present invention, there is provided a method for detecting a delinquent or dormant customer record in a customer relationship management (CRM) database, the method including the step of:
detecting, with a computer arrangement, the customer record when a future activity date associated with the customer record has passed.

The step of detecting may involve comparing a future activity date related field of the customer record with a current date stored in memory of the computer arrangement to determine that the future activity date has passed.

Prior to the step of detecting, the method may further involve the step of determining that the customer record does not relate to a prospective customer for whom future work may be undertaken. The preceding step of determining may involve determining that a prospect related field of the customer record is not indicative of a prospective customer.

Prior to the step of detecting, the method may further include the step of determining that the customer record does not relate to an existing customer for whom work is currently in progress. The preceding step of determining may involve determining that a work in progress (WIP) related field of the customer record does not indicate that work is in progress.

Subsequent to the step of detecting, the method may further include the step of setting a delinquent related field of the customer record to indicate delinquent status.

According to another aspect of the present invention, there is provided a method for detecting delinquent or dormant customer records in a customer relationship management (CRM) database, the method including the step of:
performing the step of detecting for a plurality of customer records in the database.

The preceding method may further include the step of creating a list of the detected customer records.

The preceding method may be performed periodically.

The preceding method may further include the step of displaying windows relating to respective detected delinquent customer records.

According to another aspect of the present invention, there is provided a method for detecting a delinquent or dormant customer record in a customer relationship management (CRM) database using a computer arrangement, the method including the steps of:
determining that the customer record does not relate to an existing customer for whom work is in progress;
determining that the customer record does not relate to a prospective customer; and
detecting the customer record when a future activity date associated with the customer record has passed.

According to another aspect of the present invention, there is provided a computer arrangement for detecting a delinquent or dormant customer record in a customer relationship management (CRM) database, the computer arrangement being configured to:
detect the customer record when a future activity date associated with the customer record has passed.

The computer arrangement may consist of a single computer. Alternatively, the computer arrangement may include a computer networked to a server.

According to a further aspect of the present invention, there is provided a media, such as a magnetic or optical disk or solid state memory, containing computer readable instructions for execution by a processor of the computer arrangement to thereby perform any one of the preceding methods.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a block diagram of a computer arrangement for operating a CRM software product in accordance with an embodiment of the present invention;

FIG. 2 is a schematic view of a CRM database of the computer arrangement of FIG. 1;

FIG. 3 is a flowchart of a database update method for updating the database of FIG. 2 by a sales person using a computer;

FIG. 4 is a flowchart of a delinquent detection method for detecting multiple delinquent customer records in the database of FIG. 3 with the computer arrangement of FIG. 1;

FIG. 5 is a exemplary window displayed with the computer arrangement of FIG. 1 and relating to a delinquent customer record detected when performing the method of FIG. 4; and

FIG. 6 is a flowchart showing details relating to a step of determining if a single customer record is a delinquent customer record, the step being undertaken during the delinquent detection method of FIG. 4.

### DETAILED DESCRIPTION OF PREFERRED EMBODIMENTS

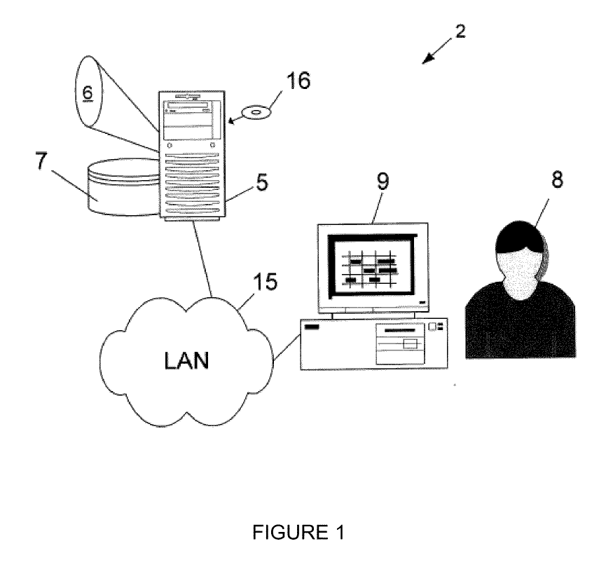

According to an embodiment of the present invention shown in FIG. 1, there is provided a computer arrangement 2 for detecting delinquent or dormant customer records in a customer relationship management (CRM) database 7. A salesperson 8 is able to use the computer arrangement 2 to detect the delinquent customer records and then contact the related customers with a view of increasing sales. The computer arrangement 2 which operates a CRM software product is described in detail below.

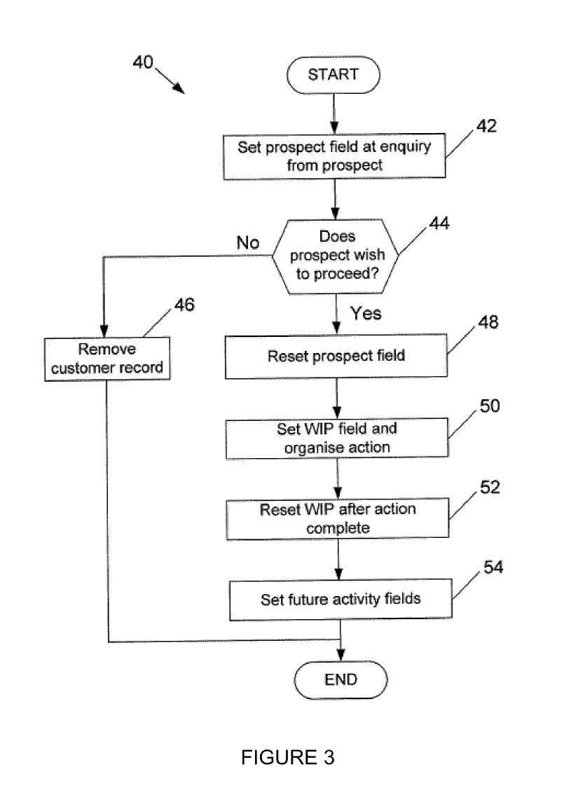

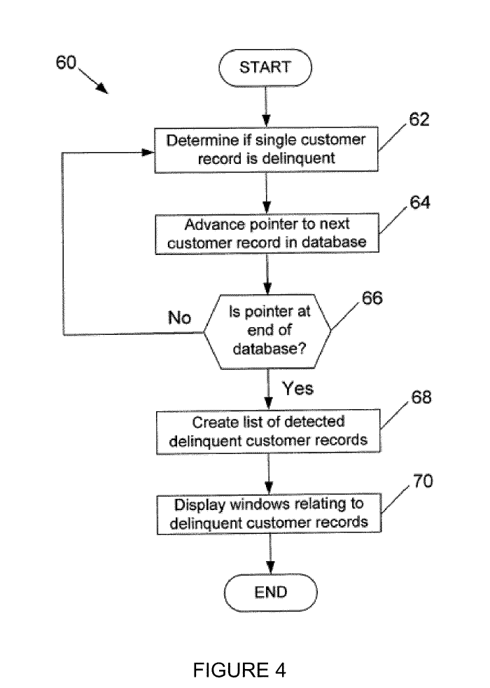

Referring to FIG. 1, there is depicted a block diagram of the computer arrangement 2. The computer arrangement 2 is based around a server 5 and personal computer 9 connected to the sever 5 via a Local Area Network (LAN) 15. The computer arrangement 2 can execute a two-part CRM software product 6 stored in the collective memory of the server 5 and computer 9. The CRM software 6 includes computer readable instructions provided on a suitable media carrier 16, such as a magnetic or optical disk or in an integrated circuit electronic memory. One or more processors of the server 5 and computer 9 execute the instructions in order to implement the database update method and delinquent detection method described in detail below with reference to FIG. 3 and FIG. 4. It will be realised that the actual coding of the CRM software is straightforward once the methods described in relation to FIGS. 3 and 4 is comprehended.

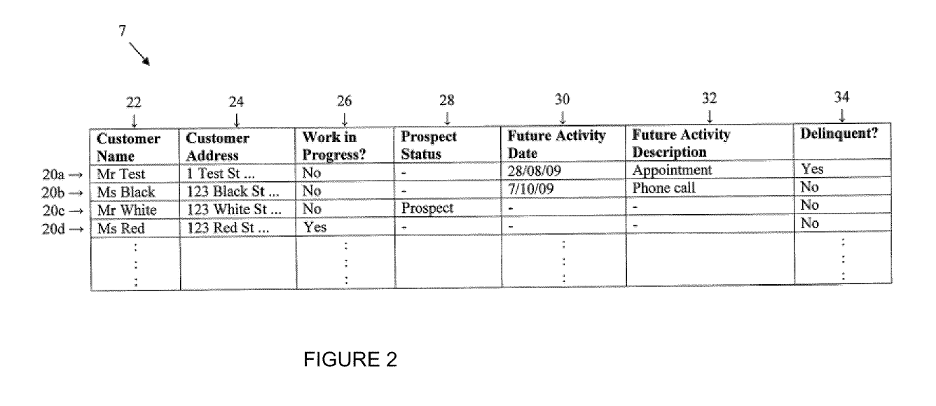

The server 5 includes a storage device defining a CRM database 7 of customer records (or entries) relating to respective customers. The customers themselves may be prospective, existing or past customers. Turning to FIG. 2, the CRM database 7 includes many customer records 20. Each customer record 20 has a plurality of fields (or parameters) including a customer name field 22, a customer address field 24, work in progress (WIP) field 26, a prospect field 28, a future activity date field 30, a future activity description field 32, and a delinquent field 34. The salesperson 8 can use computer 9 operating CRM software to access and change the customer record fields as required. A description of the customer record fields is provided below.

The customer name field 22 and customer address fields 24 include the name and address of a customer. Each customer record 20 would typically include other contact detail related fields including a telephone number field, a company website field and an e-mail address field. These contact identity fields are typically updated during the creation of a customer record 20 in the database 7 and can be amended if required.

The work in progress (WIP) field 26 is a boolean field for indicating whether an action is currently underway (e.g. an order has been placed) for an existing customer. The WIP field 26 is set by computer 9 to “Yes” after the action is initiated (e.g. after a future activity in field 32 has taken place). The WIP field 26 is set by computer 9 to “No” once the action is complete, and then future activity fields 30, 32 are set by computer 9.

The prospect field 28 can indicate the action taken for a prospective customer. This field 28 can be selected from a picklist of status options including, for example: “prospect” indicating that the customer is a prospective customer, “quoted” indicating that the prospective customer has been issued with a quotation and a response to the quotation is being awaited, “demonstration” indicating that the prospective customer has been given a product demonstration and a response to the demonstration is being awaited, and “in negotiation” indicating that negotiations between the prospective customer and salesperson 8 are current. The computer 9 sets the prospect field 28 when a new customer enquiry takes place. The computer 9 resets the prospect field 28 when a prospective customer does not proceed with a quote or becomes an existing customer (e.g. by placing an order).

The future activity date field 30 can indicate the next activity date for an existing customer. The computer 9 sets this date field 30 when an action for the exiting customer has been completed (e.g. an order is delivered).

The future activity description field 32 can indicate the nature of the next customer-related activity which is scheduled to be performed by the salesperson 8. The description field 32 may, for example, relate to an organised appointment between the customer and salesperson 8 or a telephone call that the salesperson 8 will make to the customer. The computer 9 sets this description field 32 once the date field 30 has been set.

The delinquent field 34 is a boolean field which indicates whether or not a customer record 20 is delinquent or dormant. The computer arrangement 2 operating the CRM software periodically scans each customer record 20 in the database and sets the boolean field 34 to “Yes” when the customer record 20 is determined to be a delinquent or dormant record 20, or “No” otherwise.

A database update method 40 of updating the database 7 for a single customer by the sales person 8 with computer 9 is now described with reference to FIG. 3.

At step 42, the sales person 8 takes a prospective customer enquiry from a customer named Mr White, and uses computer 9 to set the fields 22 to 34 of customer record 20c. In particular, prospect field 28 is set to “prospect”.

At query step 44, the sales person 8 queries whether the prospective customer wishes to proceed with an action (e.g. order) proposed by the sales person 8. If the prospective customer does not wish to proceed, the method 40 proceeds to step 46 where the sales person 8 uses computer 9 to remove customer record 20c from the database 7.

Alternatively, if the prospective customer does wish to proceed, the sales person 8 uses computer 9 to reset the prospect field 28 as blank at step 48.

At step 50, the sales person 8 organizes an action (e.g. order) for the customer and uses computer 9 to set the WIP field 26 to “Yes”.

At step 52, the sales person 8 receives notification of the completion of the action (e.g. order delivered) and uses computer 9 to reset WIP field 26 to “No”.

At step 54, the sales person 8 uses computer 9 to set the future activity fields 30, 32.

FIG. 4 shows a delinquent detection method 60 for detecting delinquent or dormant customer records 20 in the CRM database 7. The delinquent detection method 60 is performed automatically and periodically (e.g. daily) as a background operation.

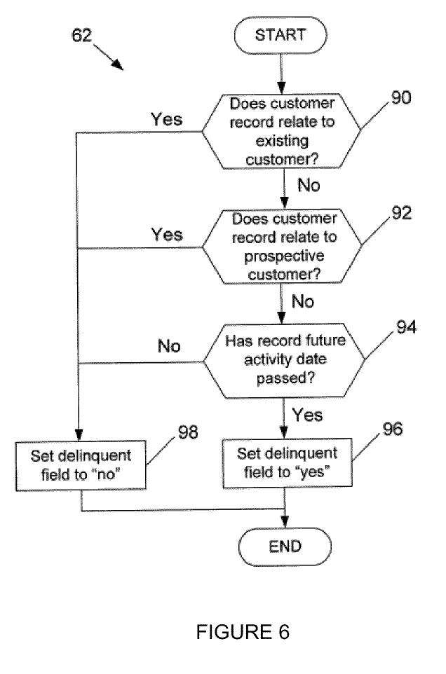

At step 62, the computer arrangement 2 determines if a single customer record 20 (to which a pointer points) is a delinquent or dormant customer record 20. This step 62 is explained in detail below with reference to FIG. 6.

At step 64, the computer arrangement 2 successively advances the pointer to the next customer record 20 in the CRM database 7.

At query step 66, the computer arrangement 2 queries whether the pointer is at the end of the database 7 whereby a delinquent determination has been made in relation to all of the customer records 20. If not, the method 60 returns to step 62 where a determination is made relating to the next customer record 20 pointed to by the pointer. If so, the method 60 proceeds to step 68.

At step 68 when a delinquent determination has been made in relation to all of the customer records 20 in the database 7, the computer arrangement 2 creates a list of detected delinquent customer records 20 for action.

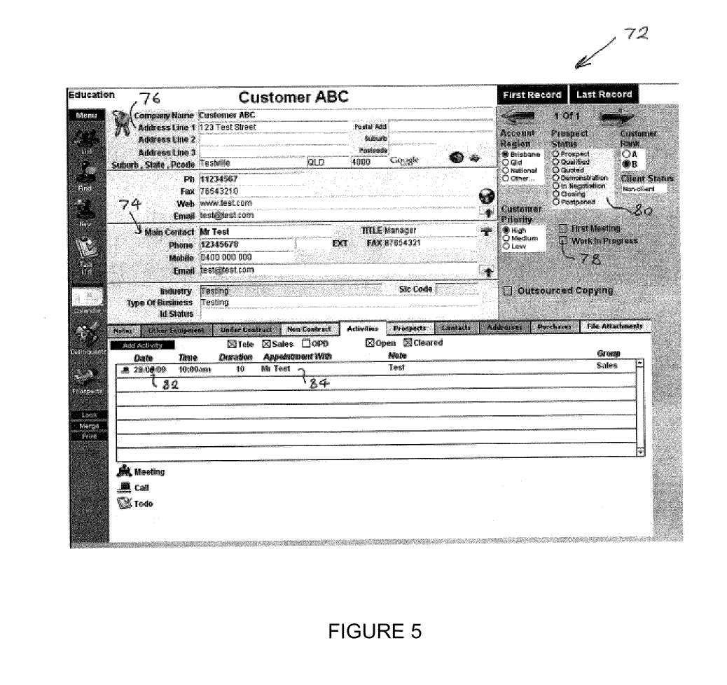

At step 70, the sales person 8 can use the computer arrangement 2 to display windows relating to respective delinquent customer records 20. FIG. 5 is an exemplary window 72 displayed with the computer 9 and which relates to the delinquent customer record 20a in FIG. 2. The window has a number of display fields corresponding to, and loaded by computer arrangement 2 with, fields in the database 7. Elaborating further, display field 74 corresponds to customer name field 22, checkbox display field 76 corresponds to customer address field 24, display field 78 corresponds to work in progress (WIP) field 26, radio button display field 80 corresponds to prospect field 28, display field 82 corresponds to future activity date field 30, and display field 84 corresponds to future activity description field 32.

The sales person 8 can then contact the neglected customer indicated by the displayed window 72 with a view of increasing sales.

FIG. 6 details step 62 of the delinquent detection method 60, which relates to determining if a single customer record 20 is a delinquent customer record. Step 62 includes the sub-steps 90 to 98 described below.

At query step 90, the computer arrangement 2 queries whether the customer record 20 relates to an existing customer for whom work (or an action) is currently in progress (e.g. an order has been placed). If work is in progress because, for example, the WIP field 26 of the customer record 20d is set to “Yes”, the delinquent detection method 60 proceeds to step 98 where delinquent field 34 is set to “No” by computer arrangement 2.

If at step 90, the computer arrangement 2 determines that the customer record 20 does not relate to an existing customer for whom work is currently in progress, the delinquent detection method 60 proceeds to step 92. For example, this determination involves determining that the WIP field 26 of the customer record 20a is set to “No” thereby indicating that there is no work in progress.

At query step 92, the computer arrangement 2 queries whether the customer record 20 relates to a prospective customer for whom future work (or action) may be undertaken. If the customer record 20 does not relate to a prospective customer because, for example, the prospect field 28 of the customer record 20c is set to a status option “prospect”, the delinquent detection method 60 proceeds to step 98 where delinquent field 34 is set to “No” by computer arrangement 2.

If at step 92, the computer arrangement 2 determines that the customer record 20 relates to a prospective customer, the delinquent detection method 60 proceeds to step 94. For example, this determination involves determining that the prospect field 28 of the customer record 20a is reset blank and is therefore not indicative of a prospective customer.

At query step 94, the computer arrangement 2 queries whether a future activity date associated with the customer record 20 has passed. If a future activity date associated with the customer record 20 has not passed because, for example, the future activity date field 30 of the customer record 20b is set to 7 Oct. 2009 whereas the current date is 7 Sep. 2009, the delinquent detection method 60 proceeds to step 98 where delinquent field 34 is set to “No” by computer arrangement 2.

If at step 94, the computer arrangement 2 determines that a future activity date associated with the customer record 20 has passed, the delinquent detection method 60 detects that the customer record is a delinquent or dormant record 20 and proceeds to step 96. For example, this determination involves comparing the future activity date field 30 (e.g. 28 Aug. 2009) of customer record 20a with the current date (e.g. 7 Sep. 2009) stored in memory of computer arrangement 2 to determine that the future activity date has passed.

At step 96, the computer arrangement 2 sets the boolean delinquent field 34 of the customer record 20 to “Yes” to indicate delinquent status.

In contrast, at step 98, the computer arrangement 2 sets the boolean delinquent field 34 of the customer record 20 to “No” to indicate non-delinquent status.

A person skilled in the art will appreciate that many embodiments and variations can be made without departing from the ambit of the present invention.

It will be appreciated that the detected delinquent or dormant customer record 20a can relate to an overlooked, neglected, dead or past customer.

The preferred embodiment was described with respect to a computer arrangement 2 including a computer 9 networked to a server 5. In one embodiment, the computer 9 may be networked to the server 5 via the Internet. In yet another embodiment, the computer arrangement 2 may consist of a single computer 9 only.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims appropriately interpreted by those skilled in the art.

The claims defining the invention are as follows:

1. A method for detecting a delinquent or dormant customer record in a customer relationship management (CRM) database using a computer arrangement, the method including the steps of:
determining that the customer record does not relate to an existing customer for whom work is in progress;
determining that the customer record does not relate to a prospective customer; and
detecting the customer record when a future activity date associated with the customer record has passed.

2. A method as claimed in claim 1, wherein the step of detecting involves comparing a future activity date related field of the customer record with a current date stored in memory of the computer arrangement to determine that the future activity date has passed.

3. A method as claimed in claim 1, wherein the step of determining that the customer record does not relate to a prospective customer involves determining that a prospect related field of the customer record is not indicative of a prospective customer.

4. A method as claimed in claim 1, wherein the step of determining that the customer record does not relate to an existing customer involves determining that a work in progress (WIP) related field of the customer record does not indicate that work is in progress.

5. A method as claimed in claim 1 which, subsequent to the step of detecting, further includes the step of setting a delinquent related field of the customer record to indicate delinquent status.

6. A method for detecting a delinquent or dormant customer record in a customer relationship management (CRM) database, the method including the step of:
detecting, with a computer arrangement, the customer record when a future activity date associated with the customer record has passed.

7. A method as claimed in claim 6, wherein the step of detecting involves comparing a future activity date related field of the customer record with a current date stored in memory of the computer arrangement to determine that the future activity date has passed.

8. A method as claimed in claim 6 which, prior to the step of detecting, further involves the step of determining that the customer record does not relate to a prospective customer for whom future work may be undertaken.

9. A method as claimed in claim 8, wherein the step of determining that the customer record does not relate to a prospective customer involves determining that a prospect related field of the customer record is not indicative of a prospective customer.

10. A method as claimed in claim 6 which, prior to the step of detecting, further includes the step of determining that the customer record does not relate to an existing customer for whom work is currently in progress.

11. A method as claimed in claim 10, wherein the step of determining that the customer record does not relate to an existing customer involves determining that a work in progress (WIP) related field of the customer record does not indicate that work is in progress.

12. A method as claimed in claim 6 which, subsequent to the step of detecting, further includes the step of setting a delinquent related field of the customer record to indicate delinquent status.

13. A method for detecting delinquent or dormant customer records in a customer relationship management (CRM) database, the method including the step of:
performing the method of claim 6 for a plurality of customer records in the database.

14. A method as claimed in claim 13, further including the step of creating a list of the detected customer records.

15. A method as claimed in claim 13, wherein the method is performed periodically.

16. A method as claimed in claim 13, further including the step of displaying windows relating to respective detected delinquent customer records.

17. A computer arrangement for detecting a delinquent or dormant customer record in a customer relationship management (CRM) database, the computer arrangement being configured to:
detect the customer record when a future activity date associated with the customer record has passed.

18. A computer arrangement as claimed in claim 17 which, prior to detecting, is further configured to determine that the customer record does not relate to a prospective customer for whom future work may be undertaken.

19. A computer arrangement as claimed in claim 17 which, prior to detecting, is further configured to determine that the customer record does not relate to an existing customer for whom work is currently in progress.

20. A computer arrangement as claimed in claim 17, further configured to set a delinquent related field of the customer record to indicate delinquent status
